(19) United States
(12) Patent Application Publication
(10) Pub. No.: US 2017/0104832 A1
(43) Pub. Date: Apr. 13, 2017

(54) Predicting Overlapping Future Locations of Entities

(71) Applicant: INTERNATIONAL BUSINESS MACHINES CORPORATION, Armonk, NY (US)

(72) Inventors: James E. Bostick, Cedar Park, TX (US); John M. Ganci, JR., Cary, NC (US); Sarbajit K. Rakshit, Kolkata (IN); Kimberly G. Starks, Nashville, TN (US)

(21) Appl. No.: 14/879,690

(22) Filed: Oct. 9, 2015

(51) Int. Cl. H04L 29/08; H04L 12/24

(52) U.S. Cl. CPC H04L 67/18; H04L 67/02; H04L 41/0686

(57) ABSTRACT

A computer-implemented method, system, and/or computer program product predicts overlapping future locations of two entities. Processor(s) retrieve a set of location readings for a first entity from a positioning device that is coupled to the first entity. The set of location readings identifies a set of previous locations at which the first entity has been during a predefined period of time. The processor(s) determine a pattern of periodic visits by the first entity to a particular location from the set of previous locations and predict, based on the pattern of periodic visits, a future first entity visit to the particular location at a particular future time. The processor(s) retrieve planned travel information about a future second entity visit to the particular location by a second entity at the particular future time, and predict an overlapping future location of the first entity and the second entity at the particular future time.

### BACKGROUND

The present disclosure relates to the field of computers, and specifically to computers that are associated with positioning systems used to track entities. More specifically, the present disclosure relates to predicting that two entities will be at a same location at a same time based on readings from the positioning systems.

### SUMMARY

A computer-implemented method, system, and/or computer program product predicts overlapping future locations of two entities. One or more processors retrieve a first set of location readings for a first entity from a first positioning device that is coupled to the first entity. The first set of location readings identifies a first set of previous locations at which the first entity has been positioned during a first predefined period of time. The processor(s) determine a first pattern of periodic visits by the first entity to a first particular location from the first set of previous locations. The processor(s) predict, based on the first pattern of periodic visits, a future first entity visit to the particular location at a particular future time. The processor(s) retrieve planned travel information about a future second entity visit to the first particular location by a second entity at the particular future time. The processor(s) predict an overlapping future location of the first entity and the second entity at the particular future time by matching the predicted future first entity visit to the future second entity visit at the particular future time, and then transmit an alert to the first entity and the second entity of the predicted overlapping future location at the particular future time.

### BRIEF DESCRIPTION OF THE DRAWINGS

FIG. 1 depicts an exemplary system and network in which the present disclosure may be implemented;

FIG. 2 illustrates a relationship among a supervisory computer and resources associated with a first entity and a second entity in accordance with one or more embodiments of the present invention;

FIG. 3 is a high-level flow chart of one or more steps performed by one or more computing devices to predict overlapping future locations of two or more entities based on readings from a positioning device in accordance with one or more embodiments of the present invention;

FIG. 4 depicts a timeline of entity visits to a particular location in accordance with one or more embodiments of the present invention;

FIG. 5 depicts a cloud computing node according to an embodiment of the present disclosure;

FIG. 6 depicts a cloud computing environment according to an embodiment of the present disclosure; and

FIG. 7 depicts abstraction model layers according to an embodiment of the present disclosure.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

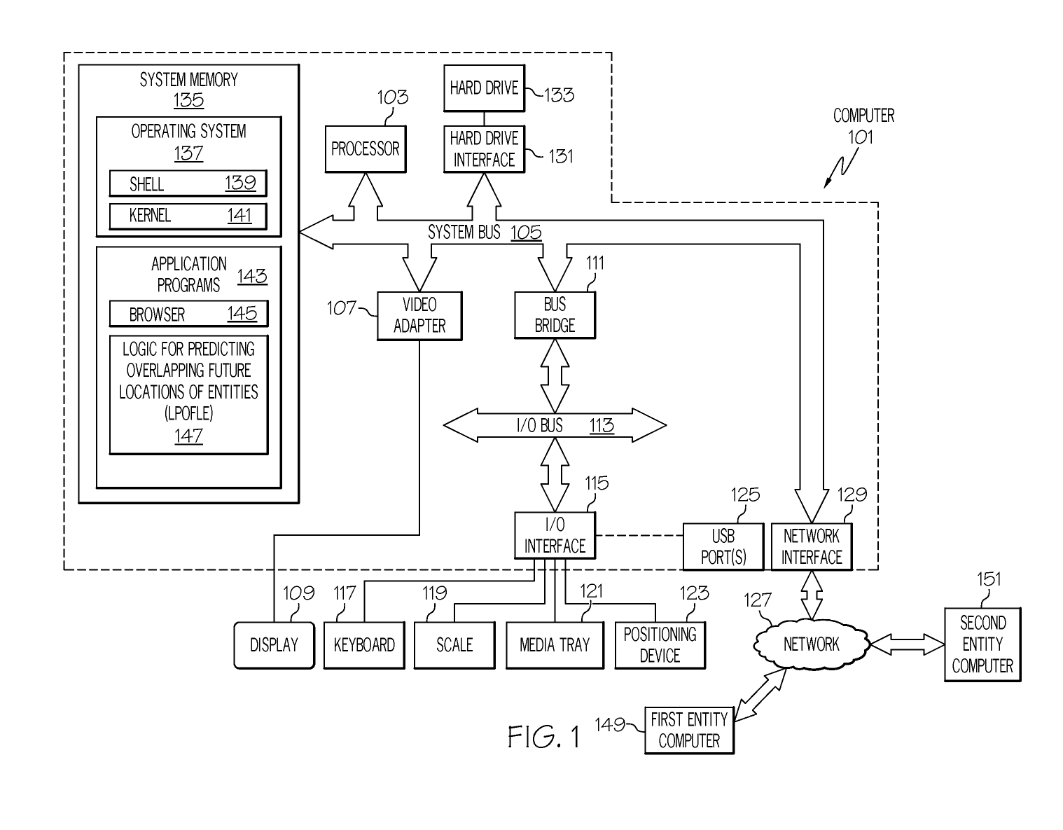

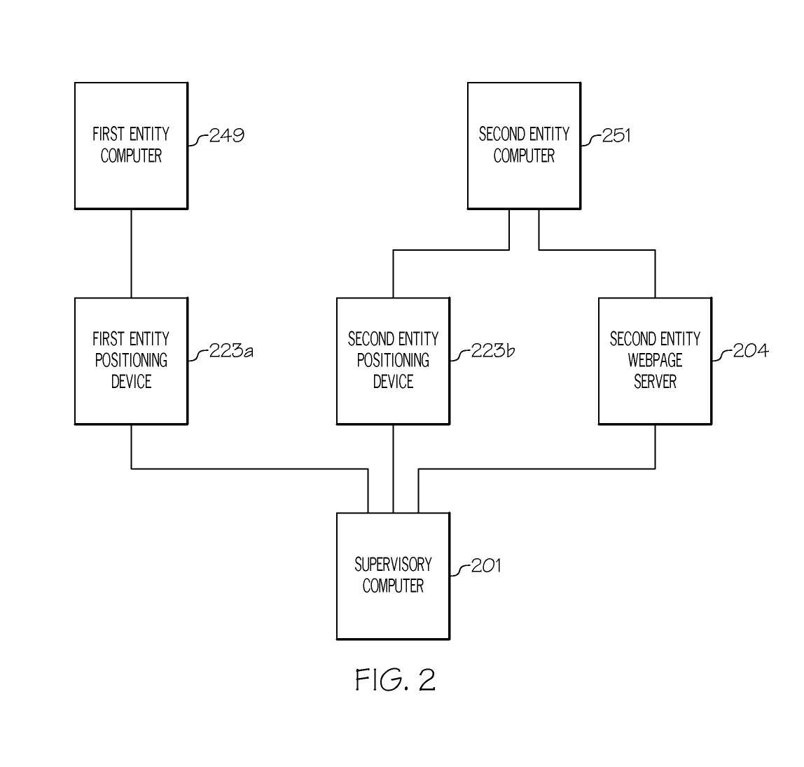

With reference now to the figures, and in particular to FIG. 1, there is depicted a block diagram of an exemplary system and network that may be utilized by and/or in the implementation of the present invention. Some or all of the exemplary architecture, including both depicted hardware and software, shown for and within computer 101 may be utilized by first entity computer 149 and/or second entity computer 151 shown in FIG. 1, and/or the second entity webpage server 204 and/or first entity computer 249 and/or second entity computer 251 shown in FIG. 2.

Exemplary computer 101 includes a processor 103 that is coupled to a system bus 105. Processor 103 may utilize one or more processors, each of which has one or more processor cores. A video adapter 107, which drives/supports a display 109, is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a scale 119 (i.e., a digital weight scale), a media tray 121 (which may include storage devices such as CD-ROM drives, multi-media interfaces, etc.), and external USB port(s) 125. While the format of the ports connected to I/O interface 115 may be any known to those skilled in the art of computer architecture, in one embodiment some or all of these ports are universal serial bus (USB) ports.

Also coupled to I/O interface 115 is a positioning device 123, which determines a position of computer 101 and/or other devices using positioning sensors. Positioning sensors may be any type of sensors that are able to determine a position of a device, including computer 101, a first entity computer 149, and/or a second entity computer 151 shown in FIG. 1, and/or the location of the entities themselves (assuming that the positioning device 123 is associated with logic that is able to interpret the sensor readings). Positioning sensors within the positioning device 123 may utilize, without limitation, satellite based positioning devices (e.g., global positioning system—GPS based devices), accelerometers (to measure change in movement), barometers (to measure changes in altitude), etc.

As depicted, computer 101 is able to communicate with the first entity computer 149 and/or the second entity computer 151 using a network interface 129. Network interface 129 is a hardware network interface, such as a network interface card (NIC), etc. Network 127 may be an external network such as the Internet, or an internal network such as an Ethernet or a virtual private network (VPN). In one or more embodiments, network 127 is a wireless network, such as a Wi-Fi network, a cellular network, etc.

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101′s operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging, thus enabling communication with first entity computer 149 and/or second entity computer 151 and/or other systems.

Application programs 143 in computer 101′s system memory also include Logic for Predicting Overlapping Future Locations of Entities (LPOFLE) 147. LPOFLE 147 includes code for implementing the processes described below, including those described in FIGS. 2-4.

The hardware elements depicted in computer 101 are not intended to be exhaustive, but rather are representative to highlight essential components required by the present invention. For instance, computer 101 may include alternate memory storage devices such as magnetic cassettes, digital versatile disks (DVDs), Bernoulli cartridges, and the like. These and other variations are intended to be within the spirit and scope of the present invention.

As presented herein and in various embodiments, the present invention provides the capability to track the reunion of social media friends and to predict upcoming reunions. By use of the present invention, social media sites are able to inform users of information that would be of interest, but of which the user would not be aware. Thus, for example, the present invention is able to inform the user that an old friend whom the user has not seen in 11 years will be in a location that the user often travels to on certain dates. With this information, the user can adjust his schedule accordingly. Social networking sites can be configured to track “active” friends and to let the user know when they will be within range of a particular radius of the user. With this information, all parties can be informed and/or advertisements of events in that area at that time can be targeted to the users based on each user's likes.

There are many instances when a user meets old friends in planned reunions or unplanned scenarios. In some cases, such parties are engaged in planning, sending invitations, and collaborating as they lead up to the event or reunion. In other cases, a user may bump into an old friend or colleague at a public location. Thus, reunions can be planned events or more impromptu in nature. Having a good understanding of knowing who will show up or who needs extra attention to ensure that they show up can be a challenge when trying to get all participants together. Over time there is also a desire to keep a record of reunions with friends to reflect on memories of previous meetings.

Thus, the present invention enables the user to reunite with friends based on overlapping schedules, to make this information available in a timeline, and to use a predictive analysis to determine who the likely people are that will attend, particularly with regard to meeting up with old friends in circumstances that the user would not otherwise know about.

Thus, the present invention presents in one or more embodiments a new feature to social networking sites in order to visualize reunions in a time line, and in order to predict upcoming reunion possibilities. In one embodiment, software installed in social networking sites will analyze the published photographs, or will analyze mobile device data (e.g., positioning sensor readings) of different friends, and accordingly will identify the possibility of meeting up. These possibilities can be stored in a social networking timeline and can be shown, if desired, in a graphical visualization mode.

Thus, if a user is predicted to be within a configured radius in the near future of someone the system has determined to be a close friend or family member, then a matchup is performed.

For example, assume that a user has a good friend who lives in Pennsylvania. Between April 12 and April 18, this good friend is going to be in Chicago. The system is able to obtain this information through a stream of data configured from multiple sources on the friend's social media website(s) and/or positioning devices. Thus, the system knows that the good friend will be in Chicago between April 12 and April 18, and is able to determine (based on prior travel by the user) that the user is likely to be in Chicago during those same dates.

The present invention systematically determines the probability that the user and the user's friend will be at a same location at a same time, so that they can have a reunion. Based on this information and the likes and dislikes of both the user and the friend, and based on the predicted reunion times, appropriate advertising can be given to show events interesting to both parties.

In one or more embodiments, system software on a social network site for time-lining reunion possibilities and understanding the whereabouts of close friends/family provides the capability to pull in streamed data on other people from multiple sites based on the configuration of the system. In one embodiment the capability of social sites to track mobile phone chats and location data for close friends are selectively configured and allowed by particular users.

In one embodiment, the system uses natural language processing (NLP) in order to better predict where close friends may be going (e.g. “can't wait to dig into barbeque at Restaurant A” means the person is on their way to Austin, Tex.).

In one embodiment, once any photograph is published on a social networking site, software will identify the photographs where more than 2 human faces are present. The software then identifies each of the faces and will check if they are friends/family with each other. The software also identifies the date and time and location of the captured photograph, as well as how frequently any two friends or group of people are meeting with each other.

With location based service installed in mobile devices, and with the information being transmitted to social networking sites, these sites will know how frequently the friends/family are meeting with each other, or are in the same exact location.

Users can define rules and timelines will be built accordingly. For example, in one embodiment of the present invention, if a user is meeting a friend every day he may not want to track such frequent meetings. So, the user may set up a rule to create these timelines for those he sees infrequently or sporadically (monthly, quarterly, yearly).

Similarly, a friend's known whereabouts and future whereabouts can be derived from social media postings.

FIG. 2 illustrates a relationship between a supervisory computer and resources associated with a first entity and a second entity in accordance with one or more embodiments of the present invention. That is, a supervisory computer 201 (analogous to computer 101 shown in FIG. 1) is able to communicate directly to a first entity computer 249 (analogous to first entity computer 149 shown in FIG. 1) and/or to a second entity computer 251 (analogous to second entity computer 151 shown in FIG. 1), or indirectly via a first entity positioning device 223a and a second entity positioning device 223b (analogous to positioning device 123 shown in FIG. 1) and/or a second entity webpage server 204.

In one or more embodiments of the present invention, the first entity and the second entity are both persons. Thus, the present invention is directed to assisting these two persons in meeting together at a particular location at a particular time in the future. However, in another embodiment, one or both of the first entity and the second entity are devices, such as equipment, mechanisms, vehicles, aircraft, etc. For example, a person may travel to a certain city on a routine and periodic basis (e.g., the first Tuesday of every third month). The person may want to inspect a particular aircraft at that time. The present invention thus allows online information (e.g., a maintenance schedule that is posted online) and/or positioning data from positioning sensors on the aircraft to predict and/or confirm that the aircraft will be in that city at the same time as the person.

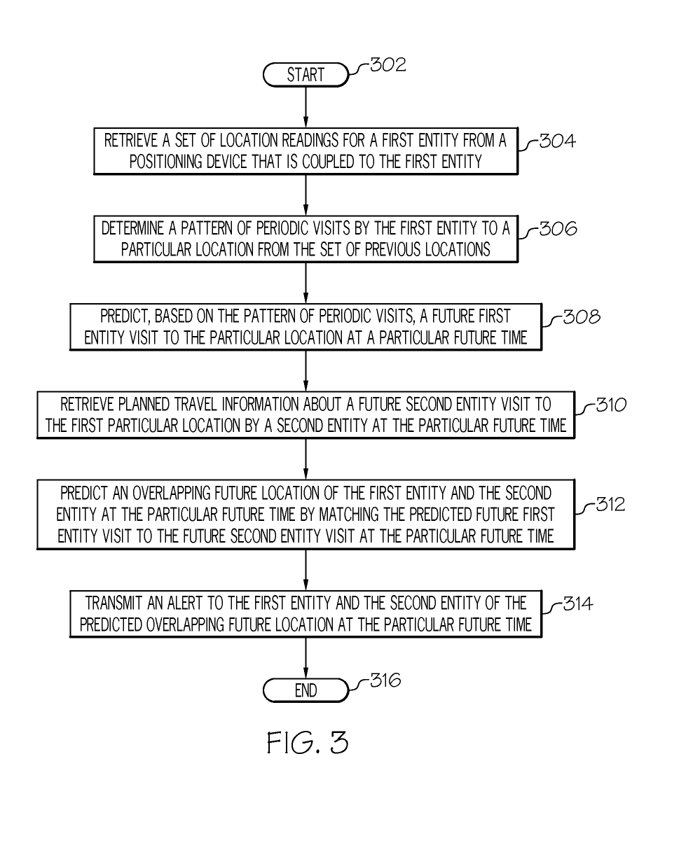

With reference now to FIG. 3, a high-level flow chart of one or more steps performed by one or more computing devices to predict overlapping future locations of two or more entities based on readings from a positioning device in accordance with one or more embodiments of the present invention is presented.

After initiator block 302, one or more processors (e.g., processors within supervisory computer 201 shown in FIG. 2) retrieve a first set of location readings for a first entity from a first positioning device (e.g., first entity positioning device 223a shown in FIG. 2) that is coupled to the first entity, as described in block 304. For example, the first entity may be carrying a smart phone that has GPS tracking capability, or the first entity may be a vehicle that is equipped with GPS. The first set of location readings identifies a first set of previous locations at which the first entity has been positioned during a first predefined period of time. That is, the first entity positioning device determines and maintains a record of where the first entity has been in the past.

As described in block 306, one or more processors then determine a first pattern of periodic visits by the first entity to a first particular location from the first set of previous locations. For example, based on the location readings from the positioning device, a pattern can be discerned (e.g., the first entity is in City A on the first Tuesday of every third month).

As described in block 308, the one or more processors then predict, based on the first pattern of periodic visits, a future first entity visit to the particular location at a particular future time. For example, if the first entity has been in City A on the first Tuesday of every third month for the past year (e.g., March, June, September, and December), then the system will predict that this same first entity will be in City A on the first Tuesday of the next third month of the next year (e.g., March of the following year).

As described in block 310, the one or more processors retrieve planned travel information about a future second entity visit to the first particular location by a second entity at the particular future time. That is, based on social media entries, positioning sensor readings, etc. as described herein, the processor(s) will retrieve information about where and when the second entity will be traveling. This information may be taken directly from a social media webpage for the second entity that is served up by the second entity webpage server 204 shown in FIG. 2, or it may be derived from positioning readings from the second entity positioning device 223b shown in FIG. 2 in the manner described above for predicting where the first entity will be.

As described in block 312, the one or more processors predict an overlapping future location of the first entity and the second entity at the particular future time by matching the predicted future first entity visit to the future second entity visit at the particular future time. That is, if the predicted time and location of the first entity and the predicted time and location of the second entity match, then the time/location match.

As described in block 314, based on this match, the one or more processors transmit an alert to the first entity and the second entity of the predicted overlapping future location at the particular future time. That is, the first entity and the second entity are alerted to the fact that they are likely to be in the same place at the same time in the future.

The flow chart ends at terminator block 316.

In one embodiment of the present invention, the processor(s) detect the first entity and the second entity in a same photograph (e.g., from a posting on a social media website). In response to detecting the first entity and the second entity in the same photograph, the processor(s) issue a recommendation to the first entity and the second entity to meet at the predicted overlapping future location at the particular future time. That is, by identifying two persons in a same photograph on a social media website (from name “tagging” or other metadata or through the use of image recognition software), the system will assume that the persons in the photograph are friends who would like to be advised of the fact that they are likely to be in the same place at the same time in the future.

In one embodiment of the present invention, the processor(s) retrieve text from a social media website to identify the future second entity visit to the particular location by the second entity at the particular future time. That is, if the second entity has a social media website, and has posted “I′ll be in Austin this Thursday”, then the future location/date of where the second entity will be is derived by the system extracting this information from that website.

In one embodiment of the present invention, the processor(s) generate and display a timeline on an electronic display. This timeline depicts the first pattern of periodic visits by the first entity, the future first entity visit to the particular location at the particular future time, the future second entity visit to the first particular location by the second entity, and the overlapping future location of the first entity and the second entity.

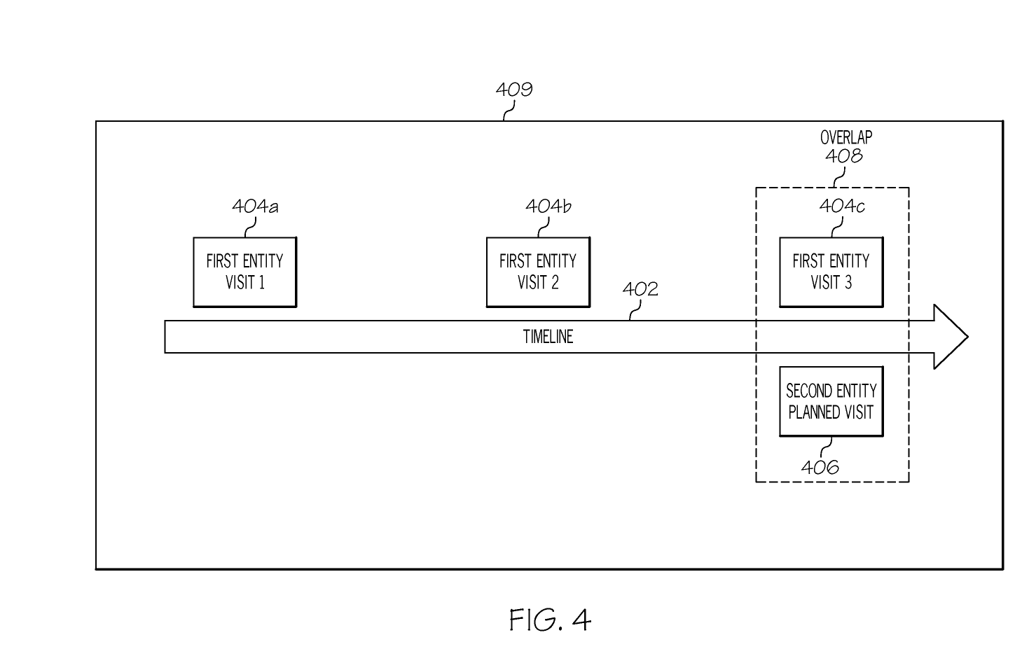

For example, consider FIG. 4, which depicts a timeline 402 of entity visits to a particular location. That is, timeline 402 shows the pattern of periodic visits by the first entity to a particular location in blocks 404a-404b. Timeline 402 also shows the future first entity visit to the particular location at the particular future time in block 404c. Timeline 402 also shows the future second entity visit to the first particular location by the second entity in block 406, and the overlapping future location of the first entity and the second entity using overlapping block 408.

In one embodiment of the present invention, one or more processors retrieve a second set of location readings for the second entity from a second positioning device that is coupled to the second entity, where the second set of location readings identifies a second set of previous locations at which the second entity has been positioned during a second predefined period of time. That is, just as the travel pattern of the first entity can be predicted by the pattern of movement captured by the first positioning device, so too can the travel pattern of the second entity be predicted by a pattern of movement captured by the second positioning device. This allows the processor(s) to determine a second pattern of periodic visits by the second entity to a second particular location from the second set of previous locations, and to predict, based on the second pattern of periodic visits, a future second entity visit to the second particular location at the particular future time. This leads to the processor(s) being able to predict the overlapping future location of the first entity and the second entity by matching the predicted future first entity visit to the predicted future second entity visit at the particular future time. That is, the positioning sensors for the two entities provide enough data to allow the system to predict when the two entities will be at the same location at the same time.

In one embodiment of the present invention, one or more processors identify a same activity interest held by the first entity and the second entity. The processor(s) then identify an event that is related to the same activity interest during the particular future time and the predicted overlapping future location, and notify the first entity and the second entity of the event. For example, assume that the first entity and the second entity both have social media websites, on which they post their affinity for opera. As such, if the first and second entity are going to be in New York City at the same time, then the system will recommend that they meet at a particular opera performance while they are there.

In one embodiment of the present invention, one or more processors retrieve a second set of location readings for the second entity from a second positioning device that is coupled to the second entity. The second set of location readings identifies a second set of previous locations at which the second entity has been positioned during a second predefined period of time. The processor(s) determine (or identify) an overlap frequency of the first set of previous locations for the first entity and the second set of previous locations for the second entity. In response to the overlap frequency falling below a predefined value, the processor(s) cancel the alert to the first entity and the second entity of the predicted overlapping future location at the particular future time. Alternatively, in response to the overlap frequency falling above a predefined value, the processor(s) re-issue the alert to the first entity and the second entity of the predicted overlapping future location at the particular future time. That is, if the first entity and the second entity are always together (e.g., daily—“the overlap frequency falling above a predefined value”), then there is no need to attempt to arrange a reunion between them. However, if the first entity and the second entity have not seen each other in over 20 years (“the overlap frequency falling below a predefined value”), then too much time may have elapsed for them to be interested in reconnecting.

In one or more embodiments, the present invention is implemented in a cloud environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

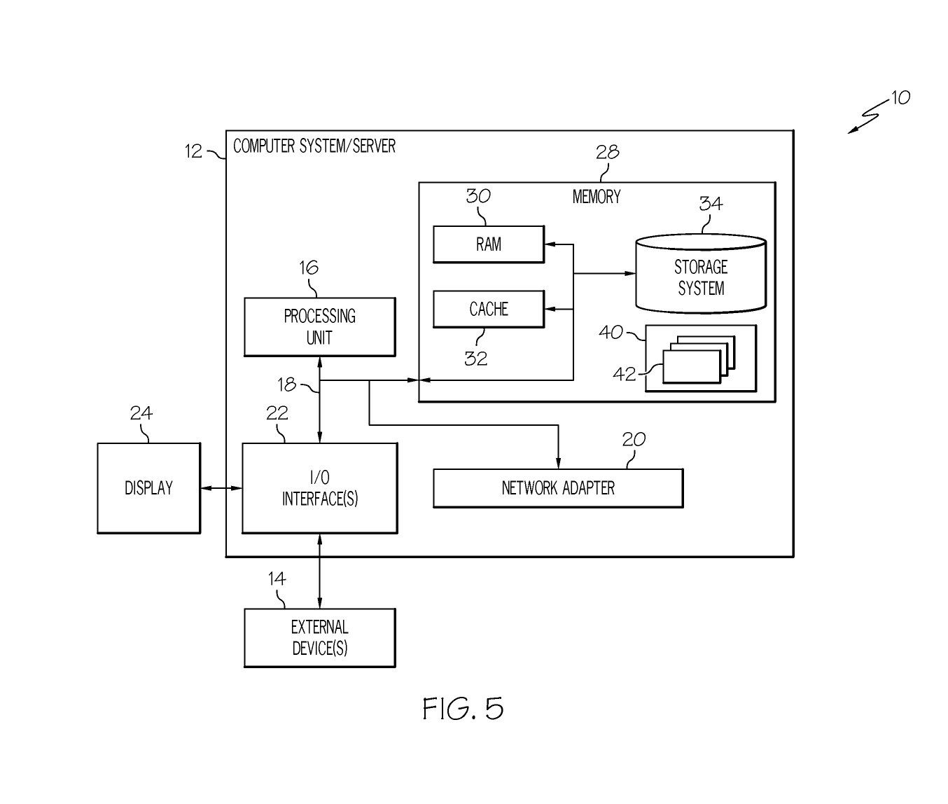

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

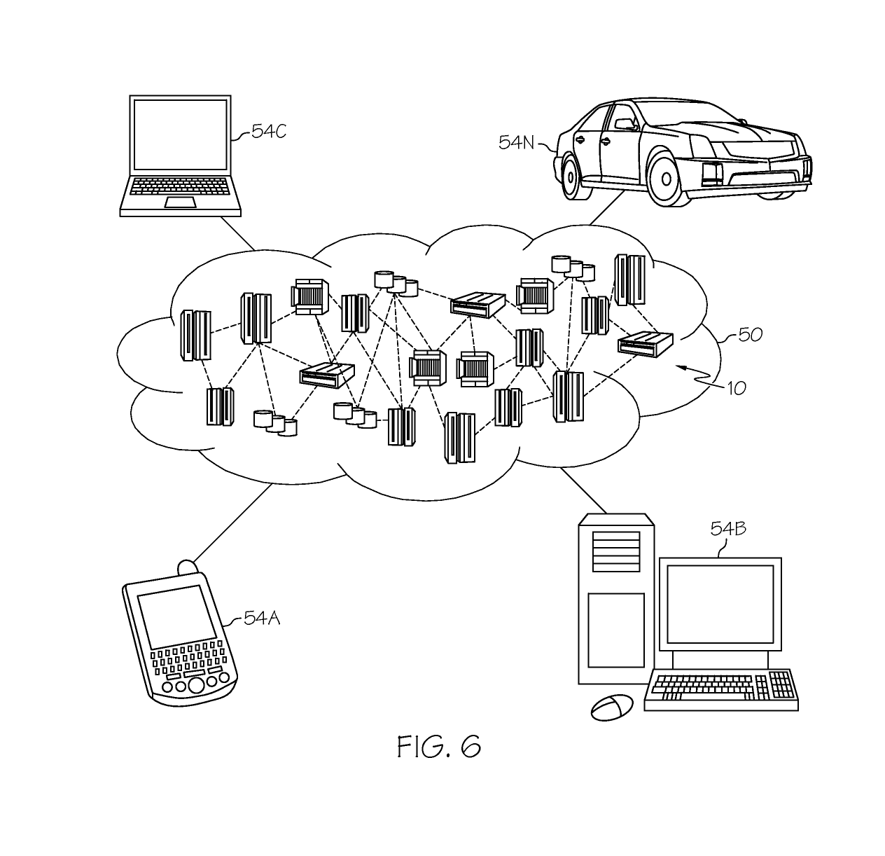

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices MA-N shown in FIG. 6 are intended to be illustrative only and that computing nodes 10 and cloud computing environment 50 can communicate with any type of computerized device over any type of network and/or network addressable connection (e.g., using a web browser).

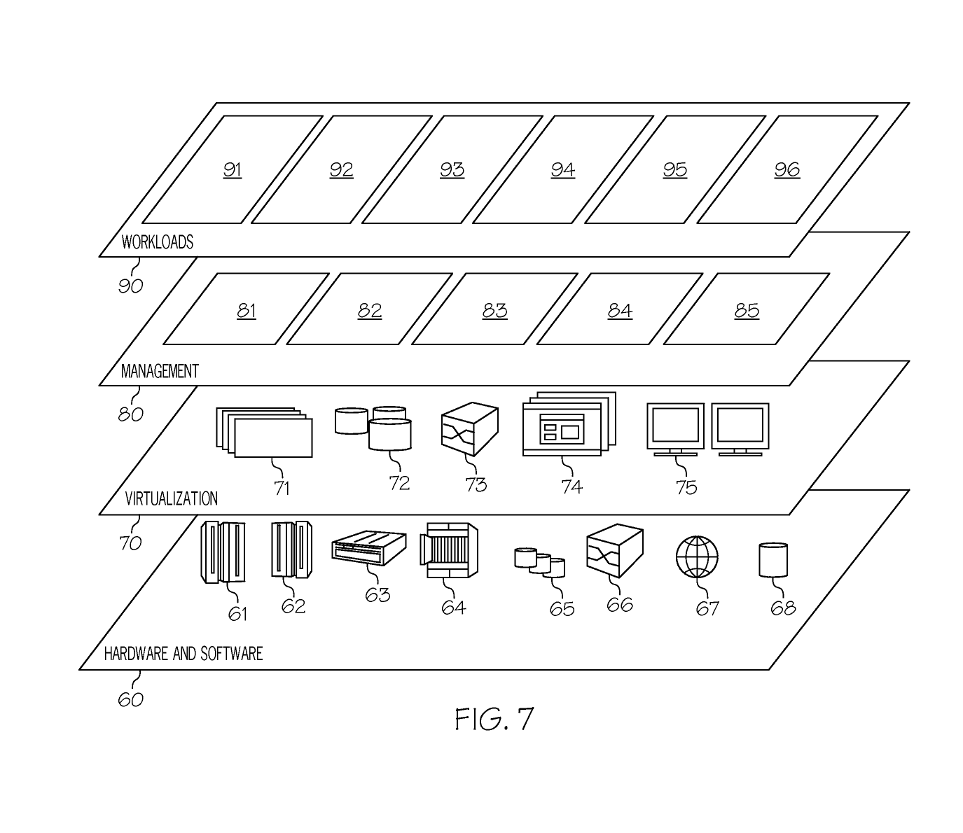

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and overlapping future location prediction processing 96 (for predicting overlapping future locations of two entities as described herein).

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A computer-implemented method of predicting overlapping future locations of two entities, the computer-implemented method comprising:
retrieving, by one or more processors, a first set of location readings for a first entity from a first positioning device that is coupled to the first entity, wherein the first set of location readings identifies a first set of previous locations at which the first entity has been positioned during a first predefined period of time;
determining, by one or more processors, a first pattern of periodic visits by the first entity to a first particular location from the first set of previous locations;
predicting, by one or more processors and based on the first pattern of periodic visits, a future first entity visit to the first particular location at a particular future time;
retrieving, by one or more processors, planned travel information about a future second entity visit to the first particular location by a second entity at the particular future time;
predicting, by one or more processors, an overlapping future location of the first entity and the second entity at the particular future time by matching the predicted future first entity visit to the future second entity visit at the particular future time; and
transmitting, by one or more processors, an alert to the first entity and the second entity of the predicted overlapping future location at the particular future time.

2. The computer-implemented method of claim 1, further comprising:
detecting, by one or more processors, the first entity and the second entity in a same photograph; and
in response to detecting the first entity and the second entity in the same photograph, issuing, by one or more processors, a recommendation to the first entity and the second entity to meet at the predicted overlapping future location at the particular future time.

3. The computer-implemented method of claim 1, further comprising:
retrieving, by one or more processors, text from a social media website to identify the future second entity visit to the particular location by the second entity at the particular future time.

4. The computer-implemented method of claim 1, further comprising:
generating and displaying, by one or more processors, a timeline on an electronic display, wherein the timeline depicts the first pattern of periodic visits by the first entity, the future first entity visit to the particular location at the particular future time, the future second entity visit to the first particular location by the second entity, and the overlapping future location of the first entity and the second entity.

5. The computer-implemented method of claim 1, further comprising:
retrieving, by one or more processors, a second set of location readings for the second entity from a second positioning device that is coupled to the second entity, wherein the second set of location readings identifies a second set of previous locations at which the second entity has been positioned during a second predefined period of time;
determining, by one or more processors, a second pattern of periodic visits by the second entity to a second particular location from the second set of previous locations;
predicting, by one or more processors and based on the second pattern of periodic visits, a future second entity visit to the second particular location at the particular future time; and
predicting, by one or more processors, the overlapping future location of the first entity and the second entity by matching the predicted future first entity visit to the predicted future second entity visit at the particular future time.

6. The computer-implemented method of claim 1, further comprising:
identifying, by one or more processors, a same activity interest held by the first entity and the second entity;
identifying, by one or more processors, an event that is related to the same activity interest during the particular future time and the predicted overlapping future location; and
notifying, by one or more processors, the first entity and the second entity of the event.

7. The computer-implemented method of claim 1, further comprising:
retrieving, by one or more processors, a second set of location readings for the second entity from a second positioning device that is coupled to the second entity, wherein the second set of location readings identifies a second set of previous locations at which the second entity has been positioned during a second predefined period of time;
determining, by one or more processors, an overlap frequency of the first set of previous locations for the first entity and the second set of previous locations for the second entity; and
in response to the overlap frequency falling below a predefined value, cancelling, by one or more processors, the alert to the first entity and the second entity of the predicted overlapping future location at the particular future time.

8. The computer-implemented method of claim 1, further comprising:
retrieving, by one or more processors, a second set of location readings for the second entity from a second positioning device that is coupled to the second entity, wherein the second set of location readings identifies a second set of previous locations at which the second entity has been positioned during a second predefined period of time;
determining, by one or more processors, an overlap frequency of the first set of previous locations for the first entity and the second set of previous locations for the second entity; and
in response to the overlap frequency falling above a predefined value, re-issuing, by one or more processors, the alert to the first entity and the second entity of the predicted overlapping future location at the particular future time.

9. A computer program product for predicting overlapping future locations of two entities, the computer program product comprising a non-transitory computer readable storage medium having program code embodied therewith, the program code readable and executable by a processor to perform a method comprising:
retrieving a first set of location readings for a first entity from a first positioning device that is coupled to the first entity, wherein the first set of location readings identifies a first set of previous locations at which the first entity has been positioned during a first predefined period of time;
determining a first pattern of periodic visits by the first entity to a first particular location from the first set of previous locations;
predicting, based on the first pattern of periodic visits, a future first entity visit to the first particular location at a particular future time;
retrieving planned travel information about a future second entity visit to the first particular location by a second entity at the particular future time;
predicting an overlapping future location of the first entity and the second entity at the particular future time by matching the predicted future first entity visit to the future second entity visit at the particular future time; and
transmitting an alert to the first entity and the second entity of the predicted overlapping future location at the particular future time.

10. The computer program product of claim 9, wherein the method further comprises:
detecting the first entity and the second entity in a same photograph; and
in response to detecting the first entity and the second entity in the same photograph, issuing a recommendation to the first entity and the second entity to meet at the predicted overlapping future location at the particular future time.

11. The computer program product of claim 9, wherein the method further comprises:
retrieving text from a social media website to identify the future second entity visit to the particular location by the second entity at the particular future time.

12. The computer program product of claim 9, wherein the method further comprises:
generating and displaying a timeline on an electronic display, wherein the timeline depicts the first pattern of periodic visits by the first entity, the future first entity visit to the particular location at the particular future time, the future second entity visit to the first particular location by the second entity, and the overlapping future location of the first entity and the second entity.

13. The computer program product of claim 9, wherein the method further comprises:
retrieving a second set of location readings for the second entity from a second positioning device that is coupled to the second entity, wherein the second set of location readings identifies a second set of previous locations at which the second entity has been positioned during a second predefined period of time;
determining a second pattern of periodic visits by the second entity to a second particular location from the second set of previous locations;
predicting, based on the second pattern of periodic visits, a future second entity visit to the second particular location at the particular future time; and
predicting the overlapping future location of the first entity and the second entity by matching the predicted future first entity visit to the predicted future second entity visit at the particular future time.

14. The computer program product of claim 9, wherein the method further comprises:
identifying a same activity interest held by the first entity and the second entity;
identifying an event that is related to the same activity interest during the particular future time and the predicted overlapping future location; and
notifying the first entity and the second entity of the event.

15. The computer program product of claim 9, wherein the method further comprises:
retrieving a second set of location readings for the second entity from a second positioning device that is coupled to the second entity, wherein the second set of location readings identifies a second set of previous locations at which the second entity has been positioned during a second predefined period of time;
determining an overlap frequency of the first set of previous locations for the first entity and the second set of previous locations for the second entity; and
in response to the overlap frequency falling below a predefined value, cancelling the alert to the first entity and the second entity of the predicted overlapping future location at the particular future time.

16. The computer program product of claim 9, wherein the method further comprises:
retrieving a second set of location readings for the second entity from a second positioning device that is coupled to the second entity, wherein the second set of location readings identifies a second set of previous locations at which the second entity has been positioned during a second predefined period of time;
determining an overlap frequency of the first set of previous locations for the first entity and the second set of previous locations for the second entity; and
in response to the overlap frequency falling above a predefined value, re-issuing the alert to the first entity and the second entity of the predicted overlapping future location at the particular future time.

17. A computer system comprising:
a processor, a computer readable memory, and a non-transitory computer readable storage medium;
first program instructions to retrieve a first set of location readings for a first entity from a first positioning device that is coupled to the first entity, wherein the first set of location readings identifies a first set of previous locations at which the first entity has been positioned during a first predefined period of time;
second program instructions to determine a first pattern of periodic visits by the first entity to a first particular location from the first set of previous locations;
third program instructions to predict, based on the first pattern of periodic visits, a future first entity visit to the first particular location at a particular future time;
fourth program instructions to retrieve planned travel information about a future second entity visit to the first particular location by a second entity at the particular future time;
fifth program instructions to predict an overlapping future location of the first entity and the second entity at the particular future time by matching the predicted future first entity visit to the future second entity visit at the particular future time; and
sixth program instructions to transmit an alert to the first entity and the second entity of the predicted overlapping future location at the particular future time; and wherein
the first, second, third, fourth, fifth, and sixth program instructions are stored on the non-transitory computer readable storage medium for execution by one or more processors via the computer readable memory.

18. The computer system of claim 17, further comprising:
seventh program instructions to detect the first entity and the second entity in a same photograph; and
eighth program instructions to, in response to detecting the first entity and the second entity in the same photograph, issue a recommendation to the first entity and the second entity to meet at the predicted overlapping future location at the particular future time; and wherein
the seventh and eighth program instructions are stored on the non-transitory computer readable storage medium for execution by one or more processors via the computer readable memory.

19. The computer system of claim 17, further comprising:
seventh program instructions to retrieve a second set of location readings for the second entity from a second positioning device that is coupled to the second entity, wherein the second set of location readings identifies a second set of previous locations at which the second entity has been positioned during a second predefined period of time;
eighth program instructions to determine a second pattern of periodic visits by the second entity to a second particular location from the second set of previous locations;
ninth program instructions to predict, based on the second pattern of periodic visits, a future second entity visit to the second particular location at the particular future time; and
tenth program instructions to predict the overlapping future location of the first entity and the second entity by matching the predicted future first entity visit to the predicted future second entity visit at the particular future time; and wherein
the seventh, eighth, ninth, and tenth program instructions are stored on the non-transitory computer readable storage medium for execution by one or more processors via the computer readable memory.

20. The computer system of claim 17, further comprising:
seventh program instructions to retrieve a second set of location readings for the second entity from a second positioning device that is coupled to the second entity, wherein the second set of location readings identifies a second set of previous locations at which the second entity has been positioned during a second predefined period of time;
eighth program instructions to determine an overlap frequency of the first set of previous locations for the first entity and the second set of previous locations for the second entity; and
ninth program instructions to, in response to the overlap frequency falling below a predefined value, cancel the alert to the first entity and the second entity of the predicted overlapping future location at the particular future time; and wherein
the seventh, eighth, and ninth program instructions are stored on the non-transitory computer readable storage medium for execution by one or more processors via the computer readable memory.
